(19) United States
(12) Patent Application Publication
(10) Pub. No.: US 2020/0258317 A1
(43) Pub. Date: Aug. 13, 2020

(54) DISTRIBUTED COMPUTING SYSTEMS, GRAPHICAL USER INTERFACES, AND PROCESSOR-EXECUTABLE LOGIC FOR SELECTION MANAGEMENT AND VISUALIZATION ENGINES FOR REAL PROPERTY CONSTRUCTION

(71) Applicant: Chameleon Power, Inc., Novi, MI (US)

(72) Inventors: Daniel J. Dempsey, Northville, MI (US); Wyatt T. Eurich, Canton, MI (US); Michael Jacob Ostach, Wixom, MI (US); Karen C. Vinette, Northville, MI (US)

(73) Assignee: Chameleon Power, Inc., Novi, MI (US)

(21) Appl. No.: 16/792,710

(22) Filed: Feb. 17, 2020

Related U.S. Application Data
(63) Continuation-in-part of application No. 16/784,587, filed on Feb. 7, 2020.
(60) Provisional application No. 62/807,281, filed on Feb. 19, 2019.
(60) Provisional application No. 62/803,043, filed on Feb. 8, 2019.

(51) Int. Cl. G06T 19/20; G06F 3/0482; H04L 29/08; G06F 3/0484

(52) U.S. Cl. CPC G06T 19/20; G06F 3/0482; G06T 2210/04; G06F 3/04842; H04L 67/10

(57) ABSTRACT

Presented are computing systems and control logic for provisioning option visualization and selection management for real property development, devices for executing such logic, methods for operating such systems, and computer-readable media for carrying out such logic. A method of managing options and selections for development of a real property structure includes transmitting, via a server computer to a user's personal computing device, multiple user-selectable categories, each including multiple user-selectable options for modifying the real property structure. Each user-selectable option having a respective descriptor and graphical image. The server computer receives from the user's personal computing device selections of multiple user-selectable options, and stores, in a memory device, a user-modifiable list of the selected options. The server computer generates a graphical representation of the selected options applied to the real property structure, and displays this graphical representation to the user via an electronic display of the personal computing device.

### CROSS-REFERENCE TO RELATED APPLICATIONS

This application claims the benefit of U.S. Provisional Application No. 62/807,281, filed Feb. 19, 2019, and is a Continuation In Part of U.S. application Ser. No. 16/784,587, filed Feb. 7, 2020, which claims priority to U.S. Provisional Application No. 62/803,043, filed on Feb. 8, 2019, each of which are hereby incorporated by reference in their entirety.

### TECHNICAL FIELD

The present disclosure relates generally to the construction and renovation of real property structures. More specifically, aspects of this disclosure relate to computing systems, methods, and devices for managing and visualizing selections for real property structures.

### BACKGROUND

The real estate industry—including the residential, commercial, and industrial sectors of real estate—may be typified as the production, buying, selling, leasing, etc., of real property and the land to which it is affixed. In general, the residential real estate sector concentrates on the buying and selling of buildings and properties that are used for homes or for non-professional purposes. Comparatively, the commercial real estate sector is generally composed of non-residential properties used for business purposes, including retail and office space. Industrial real estate, on the other hand, includes buildings and properties used for manufacturing and production, such as warehouses, factories, plants, etc. A fourth sector within the real estate industry includes the buying and selling of undeveloped and vacant land, early development land, and abandoned structures intended for demolition or reuse.

As part of a real property construction or renovation project, a customer may be tasked with a myriad of selections, including structural aspects, such as floor plan, square footage, and plumbing, electric, and heating, ventilation, and air conditioning (HVAC) hardware, as well as stylistic aspects, such as color schemes, fixtures, and materials. A general contractor or developer will use these selections as the primary basis for providing the customer with a quote for completing the desired project. Due to time and resource constraints, the contractor/developer may only provide the customer with a limited number of options for each category; oftentimes, the customer is not provided with a means to visualize available options.

### SUMMARY

A method of managing options and selections for development of a real property structure is provided herein. The method includes: transmitting, via a server computer over a distributed computing network to a personal computing device of a user, a plurality of user-selectable categories, each of the user-selectable categories including multiple user-selectable options for modifying the real property structure each with a respective descriptor and a respective graphical image; receiving, via the server computer over the distributed computing network from the personal computing device of the user, selections of multiple ones of the user-selectable options; storing, via the server computer in a memory device, a user-modifiable list of the selected ones of the user-selectable options; generating, via the server computer, a graphical representation of the selected options applied to the real property structure; and displaying, to the user via an electronic display of the personal computing device, the graphical representation of the selected options applied to the real property structure.

A distributed computing system for managing options and selections for development of a real property structure is provided herein. The distributed computing system includes a personal computing device of a user and a server computer. The personal computing device of the user is configured to communicate over a distributed computing network. The server computer has a memory device, a communication device configured to communicate over the distributed computing network, and a processor communicatively connected to the personal computing device via the communications device. The processor is programmed to: transmit, to the personal computing device of the user, a plurality of user-selectable categories, each of the user-selectable categories including multiple user-selectable options for modifying the real property structure each with a respective descriptor and a respective graphical image; receive, from the personal computing device of the user, selections of multiple ones of the user-selectable options; store, in the memory device, a user-modifiable list of the selected ones of the user-selectable options; generate a graphical representation of the selected options applied to the real property structure; and display, to the user via an electronic display of the personal computing device, the graphical representation of the selected options applied to the real property structure.

The above summary is not intended to represent every embodiment or every aspect of the present disclosure. Rather, the foregoing summary merely provides an exemplification of some of the novel concepts and features set forth herein. The above features and advantages, and other features and attendant advantages of this disclosure, will be readily apparent from the following detailed description of illustrated examples and representative modes for carrying out the present disclosure when taken in connection with the accompanying drawings and the appended claims. Moreover, this disclosure expressly includes any and all combinations and subcombinations of the elements and features presented above and below.

### BRIEF DESCRIPTION OF THE DRAWINGS

FIG. 1 is a schematic diagram illustrating a representative distributed computing system architecture for carrying out the disclosed selection visualization and management techniques in accordance with aspects of the present disclosure.

FIGS. 2-4 are screenshots showing representative graphical user interfaces for performing option visualization and selection management for real property construction and renovation in accordance with aspects of the present disclosure.

FIG. 5 is a flowchart illustrating a representative algorithm for performing option visualization and selection management for real property construction and renovation, which may correspond to memory-stored instructions executed by control logic circuitry, programmable electronic control unit, or other computer-based device or network of devices in accord with aspects of the disclosed concepts.

FIGS. 6A and 6B are a flowchart illustrating a method for process flow in the distributed computing system in accordance with aspects of the present disclosure.

The present disclosure is amenable to various modifications and alternative forms, and some representative embodiments are shown by way of example in the drawings and will be described in detail herein. It should be understood, however, that the novel aspects of this disclosure are not limited to the particular forms illustrated in the above-enumerated drawings. Rather, the disclosure is to cover all modifications, equivalents, combinations, subcombinations, permutations, groupings, and alternatives falling within the scope of this disclosure as encompassed by the appended claims.

### DETAILED DESCRIPTION

Disclosed herein are distributed computing systems and attendant control logic for provisioning selection management and visualization for real property construction and renovation, integrated circuit (IC) devices for executing such control logic, methods for operating such systems, and processor-executable programs and computer-readable media for carrying out such logic. In an example, there is presented a visualization web engine that provides a fully integrated selections/visualization/lead generation service that combines multiple facets of home builder tools into an interactive and immersive builder platform. Integrating different platforms, such as a digital selections guide, a home visualizer, a digital swatch/colorizer engine, and a lead generation platform, provides a suite for users to generate and modify a dynamic and interactive model of a building structure. virtual reality (VR) and augmented reality (AR) technology may be used to allow users to configure, design, and simulate product selections, including glass, flooring, siding, roofing, coatings, and more. While many aspects of this disclosure are discussed with respect to the new construction of residential homes, disclosed features are similarly applicable to commercial and industrial structures (residential, commercial, and industrial real estate collectively referred to herein as “real property structures”), including both new constructions and renovations (collectively referred to herein as “developments”).

Aspects of this disclosure are directed to distributed computing systems, personal computing devices, webpages, and dedicated mobile software applications (“apps”) for carrying out any of the disclosed features. In an example, a distributed computing system includes a resident or remote memory device configured to store user inputs, processor-executable instructions, and related data. A communications device is configured to communicate, wired or wirelessly over a distributed computing network, with a remote database system and a user's personal computing device. A server computer with a processor is communicatively connected to the user's personal computing device via the communications device. The processor is programmed to transmit multiple user-selectable categories to the personal computing device of the user. Each user-selectable category includes multiple user-selectable options for modifying the real property structure, with each option having a respective descriptor and a respective graphical image. The server computer processor receives, from the user's personal computing device, selections of multiple user-selectable options and stores a user-modifiable list of these selections in the memory device. The processor also generates a graphical representation of the selected options applied to the real property structure. This graphical representation of the selected options applied to the real property structure is displayed to the user via an electronic display of the personal computing device.

Other aspects of the disclosure are directed to control logic, processor-executable, memory-stored computer readable media, and computer programs for provisioning any of the disclosed methods and techniques. In an example, a method is presented for managing options and selections for development of a real property structure. This representative method includes, in any order and in any combination with any of the above and below disclosed options and features: transmitting, via a server computer over a distributed computing network to a personal computing device of a user, a plurality of user-selectable categories, each of the user-selectable categories including multiple user-selectable options for modifying the real property structure each with a respective descriptor and a respective graphical image; receiving, via the server computer over the distributed computing network from the personal computing device of the user, selections of multiple ones of the user-selectable options; storing, via the server computer in a memory device, a user-modifiable list of the selected ones of the user-selectable options; generating, via the server computer, a graphical representation of the selected options applied to the real property structure; and displaying, to the user via an electronic display of the personal computing device, the graphical representation of the selected options applied to the real property.

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference or otherwise. For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “approximately,” and the like, may be used herein in the sense of “at, near, or nearly at,” or “within 0-5% of,” or “within acceptable manufacturing tolerances,” or any logical combination thereof, for example.

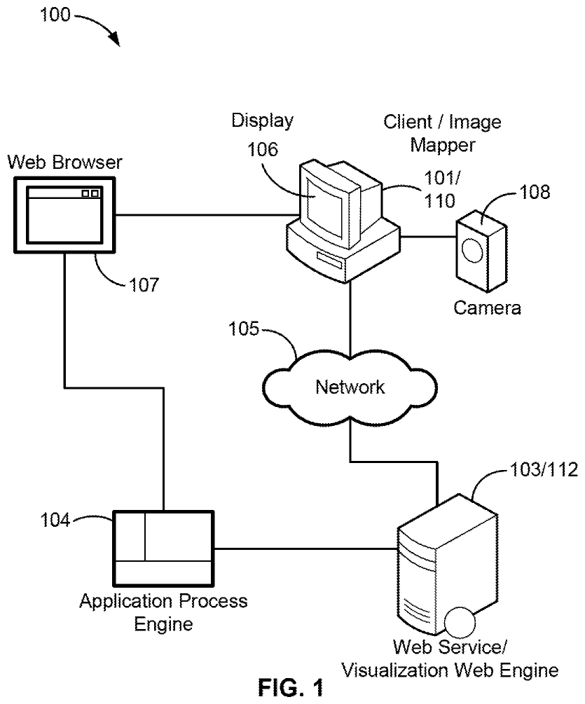

Referring now to the Figures, wherein like reference numbers refer to like features throughout the several views, there is shown illustrated in FIG. 1 a schematic diagram of a representative distributed computing system 100 operable for a user to perform electronic image processing and selection visualization. The illustrated computing system 100 is merely an exemplary application with which aspects and features of this disclosure may be practiced. In the same vein, implementation of the present concepts for home building and/or repair projects should also be appreciated as an exemplary application of the novel features disclosed herein. As such, it will be understood that aspects and features of this disclosure may be implemented through other distributed computing system architectures, carried out on any suitable integrated circuit (IC) device, and utilized for any logically relevant application.

Referring to FIG. 1, a schematic diagram is shown illustrating a representative architecture of a distributed computing system 100 for carrying out selection visualization and management techniques in accordance with aspects of the present disclosure. The distributed computing system 100 generally comprises a client computer 101, a web service computer 103, an application process engine 104, a distributed computer network 105, an electronic display 106, a web browser 107, a camera 108, an image mapper software application 110 and the visualization web engine 112.

Aspects of the present disclosure implement the “image mapper” software application 110 stored within and executing on the client computer 101. The image mapper software application 110 may be configured for visualization and mapping of one or more objects in one or more digital images provided by one or more electronic files.

In accordance with the representative distributed computing system 100 of FIG. 1, the client computer 101 comprises a personal computing device. In various embodiments, the client computer 101 may be a cellular telephone, a personal desktop computer, a personal notebook computer, a hand-held computing device, a personal digital assistant or any variant thereof. The client computer 101 may include one or more processors for executing software and one or more non-transitory memories configured to store the software, including the web browser software 107 and the image mapper software 110. The client computer 101 may be programmed with the image mapper software 110 wherein, in general, the image mapper software 110 maps points on a user-supplied digital image. For example, the client computer 101 executing the image mapper software 110 generally enables a user to remotely perform a decorating session on the user-supplied digital image wherein the user-supplied digital image has an area to be modified. The area may be interactively mapped with one or more products to obtain a mapped image. In this way, the mapped image may be dynamically altered online at a web site via the distributed computer network 105.

The web service computer 103 may be embodied as one or more server computers, a host system implemented through a high-speed, server-grade computing device or a mainframe computer capable of handling bulk data processing, resource planning, and transaction processing. For instance, the web service computer 103 may operate as the host in a client-server interface for conducting any data exchanges and communications with one or more “third party” servers to complete a particular transaction. Alternatively, the web service computer 103 may be implemented as a middleware node to provide different functions for dynamically onboarding heterogeneous devices, multiplexing data from each of these devices, and routing the data through reconfigurable processing logic for processing and transmission to one or more destination applications.

The web service computer 103 may include one or more processors for executing software and one or more non-transitory memories configured to store the software. The web service computer 103 may store and execute the application process engine 104 software and the visualization web engine 112 software. In various embodiments, the web service computer 103 may be remotely located from the client computer 101. By way of example, the client computer 101 may within the same building, but in a different room as the web service computer 103. In other examples, the client computer 101 may be remotely located in another building, city, state or country as the web service computer 103.

The application processing engine 104 may implement a software application executed on the web service computer 103. The application processing engine 104 is generally operational to interpret image and mapping data received from the client computer 101.

The distributed computer network 105 may implement a digital communication network for communicatively connecting the client computer 101 to the web service computer 103. The distributed computer network 105 may be any available type of network, including a combination of public distributed computing networks (e.g., Internet) and secured private networks (e.g., local area network, wide area network, virtual private network). The distributed computer network 105 may also include wireless and wireline transmission systems (e.g., satellite, cellular network, terrestrial networks, etc.). In at least some aspects, most if not all data transaction functions carried out by the client computer 101 may be conducted over a wireless network, such as a wireless local area network (WLAN) or cellular data network, to ensure freedom of movement of the user.

The electronic display 106 may be implemented as one or more visual display devices. The electronic display 106 may include, but is not limited to, a two-dimensional computer display, a virtual reality display and/or an augmented virtual reality display. The electronic display 106 is generally operational to show the user the user-supplied digital images before, during, and after modifications by the image mapper software 110. In various embodiments, the electronic display 106 may be integrated in the client computer 101. In other embodiments, the electronic display 106 may be a separate device than the client computer 101.

The web browser 107 may implement one or more commercially available software applications. The web browser 107 is generally operational to access data on the World Wide Web via the distributed computing network 105. When a web site is requested, the web browser 107 retrieves the requested content from a web server (e.g., the web service computer 103) and presents the resulting web page on the electronic display 106.

The camera 108 may implement one or more digital cameras. The camera 108 is generally operational to generate digital files of the user-supplied digital images. In various embodiments, the camera 108 may be integrated into the client computer 101. In other embodiments, the camera 108 may be a separate device from the client computer 101. Where the camera 108 is a separate device, the camera 108 may communicate the digital files to the client computer 101 via wired and/or wireless connections. The camera 108 may include, but is not limited to, a still camera, a video camera, and a hybrid video/still camera.

The image mapper software 110 may be implemented as software tool executed on the client computer 101. The image mapper software 110 is generally operational to specify multiple features to specific locations of the digital images supplied by the user and point the features to a document or website. The image mapper software 110 may create mouseover text, alternative text, links and the like. The visualization web engine 112 may be implemented as a software tool executed on the web service computer 103. The visualization web engine 112 is generally operational to provide the client computer 101 with a variety of pages and navigation tools that provide customer-facing visualization solutions. The visualization web engine 112 may generate a scalable combination of checklists, selections, photographic and three-dimensional visualizations, a swatching tool and a pricing module.

In accord with a non-limiting example, a user-generated digital image stored on the client computer 101 (e.g., via the digital camera 108) is sent in a data packet or other similarly suitable electronic file format from the client computer 101, over the distributed computing network 105 to the web service computer 103. The web service computer 103 receives the user-supplied digital image, along with mapping data that is generated at the image mapper software 110. At the web service computer 103, the image and mapping data are processed so that the application process/rendering engine 104 can interpret the image and the mapping data. The web browser 107, opened via the image mapper software application 110 operating on the client computer 101, directs the client computer 101 to the mapped image. The web browser 107 subsequently retrieves a copy of the mapped image from the web service computer 103. The electronic display 106 of the client computer 101 may present the retrieved mapped image to the end user (client) where the user is provided with numerous options for changes surfaces of objects present in the mapped image.

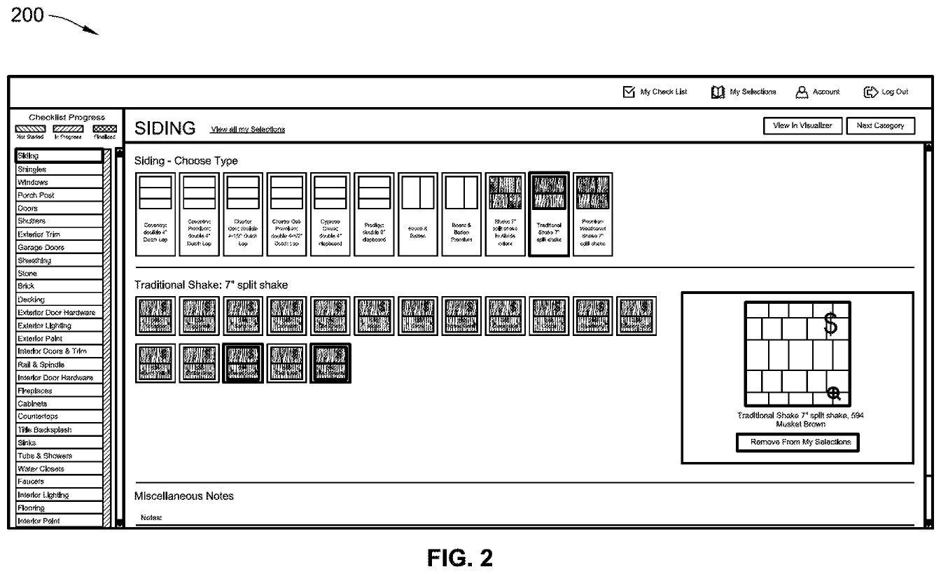

FIGS. 2-4 are screenshots of representative graphical user interfaces (GUI) of the visualization web engine 112 that cooperatively enables the user to perform selection management and visualization for development of a real property structure. The various graphical user interfaces may be generated by the visualization web engine 112 and transmitted to the client computer 101 via the distributed computing network 105.

Referring to FIG. 2, an illustration of an example interactive “My Check List” graphical user interface 200 is shown. The graphical user interface 200 generally enables a user to select from multiple categories of modifiable elements of a real property structure, such as siding, shingles, windows, porch posts, doors, shutters, exterior trim, garage doors, sheathing, stone, brick, decking, exterior door hardware, exterior lighting, exterior paint, interior doors and trim, rails and spindles, interior door hardware, fireplaces, cabinets, countertops, tile backsplash, sinks, tubs and showers, water closets, faucets, flooring, interior paints, etc., and select from within each category multiple options for modifying a real property structure, such as different colors, textures, types, etc. For example, the “My Check List” graphical user interface 200 may provide the user with a variety of siding selection. The selections may include types of siding, such as coventry charter cypress prodigy, board&batten, shake, traditional, etc. After a particular type of siding is selected, the “My Check List” graphical user interface 200 may show a variety of available colors for the particular siding. Once all desired selections are made, the user may advance to an interactive “My Selections” graphical user interface 300.

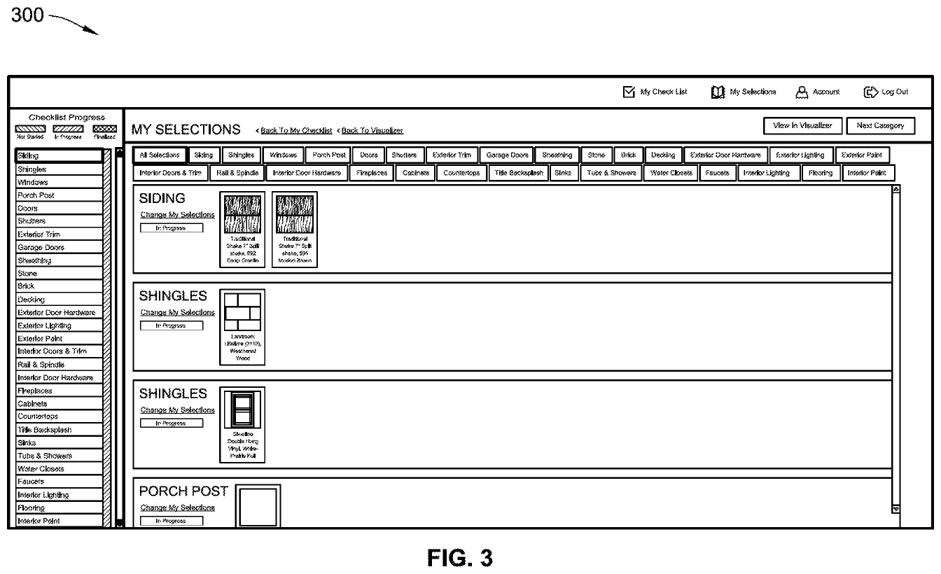

Referring to FIG. 3, an illustration of an example interactive “My Selections” graphical user interface 300 is shown. The graphical user interface 300 generally enables a user to view, manage, and transmit the selections (e.g., for saving, printing, or viewing by a third party). The “My Selections” graphical user interface 300 may include tabs for each of the selections available on the “My Check List” graphical user interface 200 that enable the user to navigate back to the selections to make updates.

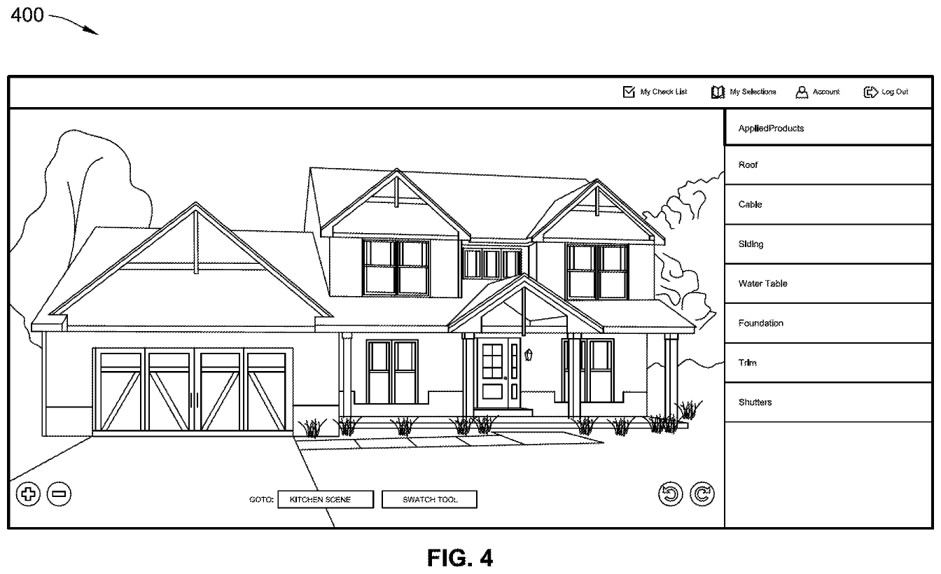

Referring to FIG. 4, an illustration of an example interactive “Selection Visualizer” graphical user interface 400 is shown. The “Selection Visualizer” graphical user interface 400 may enable a user to dynamically view and modify a graphical representation of the selected options applied to the real property structure. The visualization experience may be presented in any suitable format, including web-based service, native application, virtual reality, augmented virtual reality, or any combination thereof. The “Selection Visualizer” graphical user interface 400 generally provides options for viewing the roof, a gable area, the siding, the water table, the foundation, the trim, the shutters, and the like. The “Selection Visualizer” graphical user interface 400 may include options to switch the view among exterior views of the real property structure and interior views. The interior views may include, but are not limited to, the kitchen, the dining room, the bedrooms, etc.

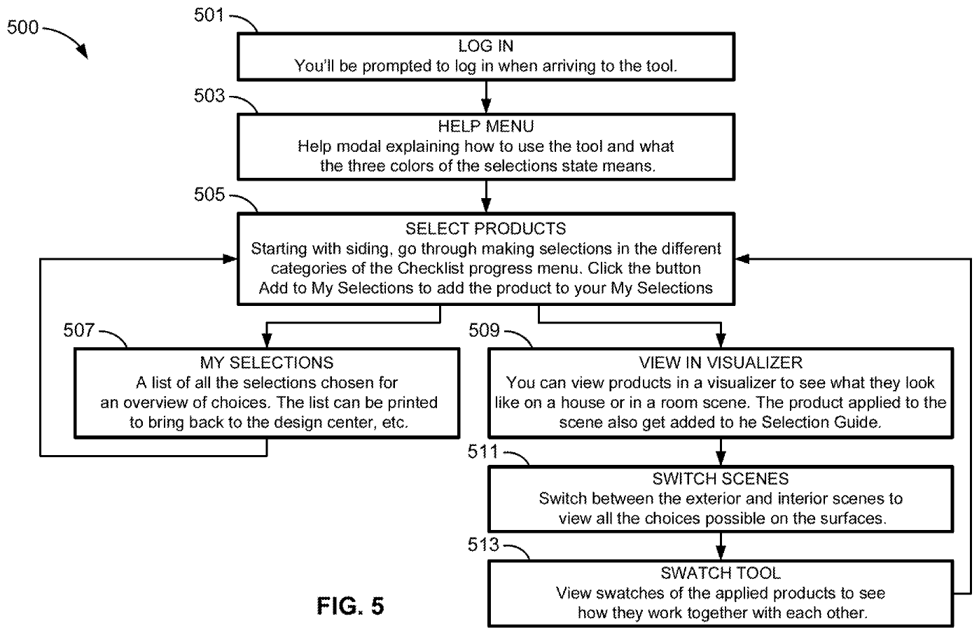

With reference now to the flowchart of FIG. 5, an example implementation of an improved method or control strategy for provisioning selection management and visualization for real property construction and renovation is generally described at method 500 in accordance with aspects of the present disclosure. Some or all of the operations illustrated in FIG. 5 and described in further detail below may be representative of an algorithm that corresponds to processor-executable instructions that may be stored, for example, in main or auxiliary or remote memory, and executed, for example, by a resident or remote controller, processing unit, control logic circuit, or other module, device and/or network of devices, to perform any or all of the above or below described functions associated with the disclosed concepts. It should be recognized that the order of execution of the illustrated operation blocks may be changed, additional blocks may be added, and some of the blocks described may be modified, combined, or eliminated.

The method 500 may be implemented by the distributed computing system 100. The method (or process) 500 generally comprises a process block 501, a process block 503, a process block 505, a process block 507, a process block 509, a process block 511 and a process block 513.

At process block 501, a back-end server (e.g., the web service computer 103) provisions a login screen to an end user at the client computer 101 with a prompt to enter personal identification information (e.g., an email and a password) when arriving at a portal of the visualization web engine 112. Method 500 continues to process block 503 with outputting an interactive help modal that helps to explain, among other things, how to use the tool and the meanings of various display colors of the selection state. The user is then provided with categories of selectable products by the visualization web engine 112, at process block 505. The categories may be transferred to the client computer 101 via the distributed computer network 105. One such category may include home siding. Upon selection of the “Siding” menu option, the user peruses through the corresponding user-selectable options in the different categories of the “Checklist Progress” menu. The user may then click on an “Add to My Selections” button to add a particular product to their “My Selections” list.

Method 500 proceeds to process block 507 and generates a memory-stored list of all the selections chosen for an overview of choices. If so desired, this list may be printed, saved for later use, or transmitted to a third party. At process block 509, the user is enabled to view selected products in a visualizer to see what they look like on a house or in a room scene. A product applied to the scene may be added to a “Selection Guide.” The user may dynamically modify the graphical representation of the selected options applied to the home. For at least some implementations, process block 511 enables the user to switch back-and-forth between one or more exterior scenes and one or more interior scenes to view the user's various selections visualized on both exterior and interior surfaces of the home. A swatch tool may be provided at process block 513 which allows the user to view swatches of the applied products to see how they work together with each other.

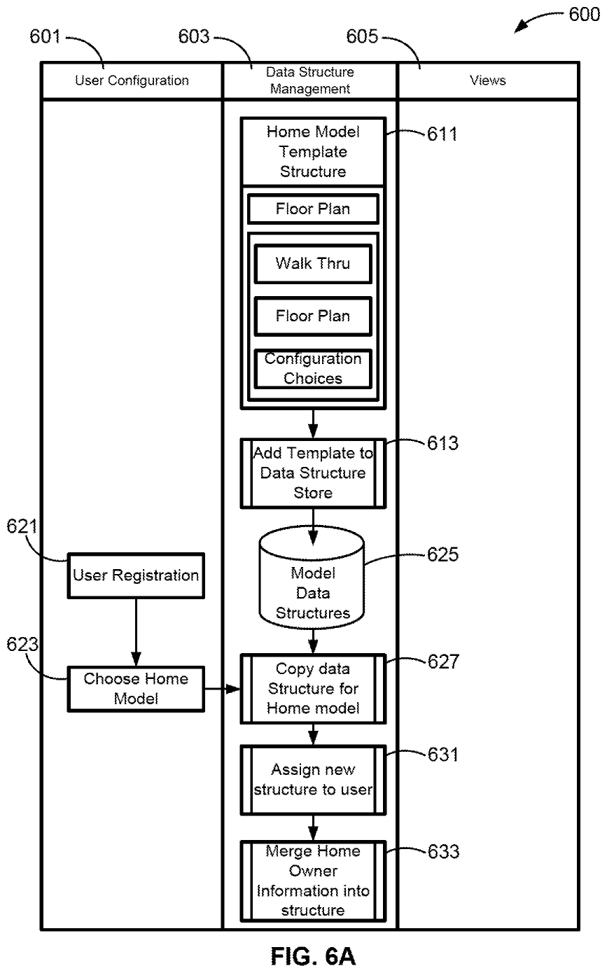

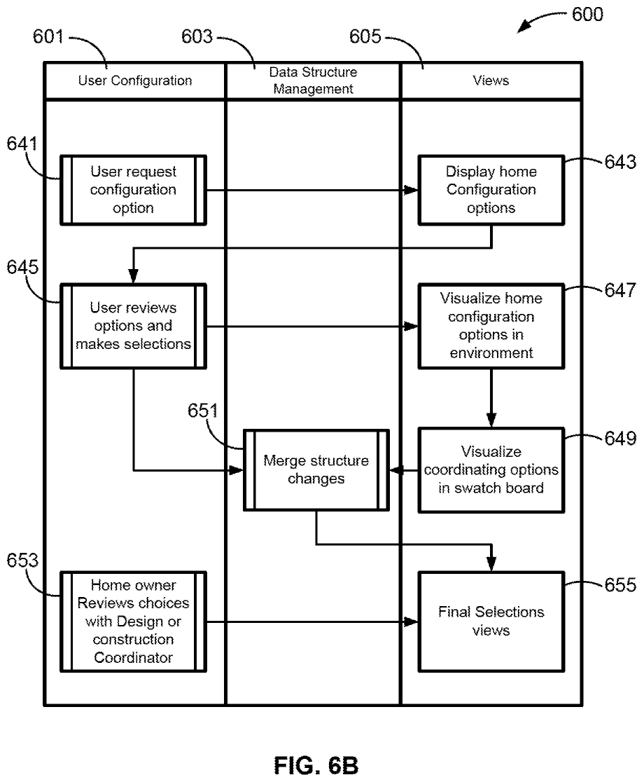

FIGS. 6A and 6B are a flowchart illustrating a method 600 for process flow in the distributed computing system 100 in accordance with aspects of the present disclosure. The method (or process) 600 generally comprises user configuration processes 601, data structure management processes 603 and view processes 605. The user configuration processes 601 may be implemented in the client computer 101. The data structure management processes 603 may be implemented in the web service computer 103. The views processes 605 may be implemented in the web service computer 103 and the web browser 107.

The method 600 may include a process block 611, a process block 613, a process block 621, a process block 623, a data structure block 625, a process block 627, a process block 629, a process block 631, a process block 633, a process block 641, a process block 643, a process block 645, a process block 647, a process block 649, a process block 651, a process block 653, and a process block 655. It should be recognized that the order of execution of the illustrated operation blocks may be changed, additional blocks may be added, and some of the blocks described may be modified, combined, or eliminated.

In the process block 611, the web service computer 103 may initialize the data structure stores for a home model template structure. The template may include multiple categories, but is not limited to, a floor plan, a roofing plan, a kitchen plan, a landscaping plan and the like. Each category may include multiple subcategories. For example, the floor plan may include a walk through subcategory, a flooring subcategory and a configuration choices subcategory. In the process block 613, the home model template structure may be stored in a data structure store within the web service computer 103 awaiting modifications by a user.

At a process block 621, a user at the client computer 101 may log into an account and be recognized by the web service computer 103. The use may subsequently select from multiple available home models in the process block 623 and transfer the selection to the web service computer 103. The web service computer 103 may extract the chosen home model from a model data structures 625 (previously initialized by the process blocks 611 and 613). The web service computer 103 may copy the data structure for the chosen home model in the process block 627. The copied data structure for the chosen home model may be assigned (or linked) to the user by the web service computer 103 in the process block 631. Home owner information of the user may be merged into the data structure for the chosen home model in the process block 633. The home owner information may include, but is not limited to, a name, an address, a telephone number, the email address and the password.

In the process block 641, the user may request configuration options via the client computer 101. The requested configuration options may be transferred to the web service computer 103 via the distributed computer network 105. The web service computer 103 may respond by presenting a home configuration options web page to the web browser 107 in the process block 643. The user generally reviews the available options in the process block 645 and records selections entered by the user. The selections may be transferred back to the web service computer 103. In the process block 647, the web service computer 103 may generate a visualization of the home configuration options. The home configuration options may be coordinated with visualization coordinating options in a currently active checklist tool, selection tool, photographic and three-dimensional visualization tool, swatching tool (as illustrated) and pricing module in the process block 649. Based on the user selection from the process bock 645 and the options from the process block 649, the web service computer 103 may merge the requested configuration options into the home model data structure in the process block 651.

In the process block 653, the user may review the entered choices with a design coordinator and/or a construction coordinator. The entered choices may be used by the web service computer 103 to generate a final-selections view based on the home model data structure in the process block 655. The user may subsequently finalize the home model data structure and/or return to the process block 645 to update the customized home model.

Embodiments of the disclosure provide a system offering a complete suite of interactive tools for the home-building industry. The system may be implemented on a distributed computing network that allows for remote access and utilization at home sites to improve the user experience. The system may track and manage user selections in multiple categories individually and/or provide a view to a checklist to see all of the selections. The checklist may be electronically transmitted to and/or physically transformed into a printed document and brought to a local dealer in the home-building industry. The list may be used to obtain written quotes, purchase materials and/or obtain skilled labor to assist with the projects. For large projects, the system enables a significant amount of information to be collected beyond what a home owner could reasonably remember. Systematic organization of the project details provides a more efficient means of gathering and presenting the information than hand-written notes made by the home owner over an extended period of time scattered on multiple sheets of paper. Therefore, the system provides a practical application of home improvement design tasks.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of non-transitory memory media, such as CD-ROM, magnetic disk, bubble memory, and semiconductor memory (e.g., various types of NVRAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software or a combination thereof, in a computer system or other processing system.

Any of the methods described herein may include machine readable instructions for execution by: (a) a processor, (b) a controller, and/or (c) any other suitable processing device. Any algorithm, software, control logic, protocol or method disclosed herein may be embodied as software stored on a non-transitory tangible medium such as, for example, a flash memory, a CD-ROM, a floppy disk, a hard drive, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms are described with reference to flowcharts depicted herein, many other methods for implementing the example machine-readable instructions may alternatively be used. Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A method of managing options and selections for development of a real property structure, the method comprising:
transmitting, via a server computer over a distributed computing network to a personal computing device of a user, a plurality of user-selectable categories, each of the user-selectable categories including multiple user-selectable options for modifying the real property structure each with a respective descriptor and a respective graphical image;
receiving, via the server computer over the distributed computing network from the personal computing device of the user, selections of multiple ones of the user-selectable options;
storing, via the server computer in a memory device, a user-modifiable list of the selected ones of the user-selectable options;
generating, via the server computer, a graphical representation of the selected options applied to the real property structure; and
displaying, to the user via an electronic display of the personal computing device, the graphical representation of the selected options applied to the real property structure.

2. The method according to claim 1, further comprising:
receiving the respective graphical images of the real property structure at the personal computing device from a digital camera; and
transmitting the respective graphical images from the personal computing device over the distributed computing network to the server computer.

3. The method according to claim 1, further comprising:
embedding the graphic representation of the selected options applied to the respective graphical images in a web page at the server computer; and
transmitting the web page from the server computer to a web browser of the personal computing device.

4. The method according to claim 1, further comprising:
receiving from the personal computing device at the server computer a model selection from a plurality of available real property structures; and
assigning a copy of a selected one of the plurality of available real property structures to the user as the real property structure within the server computer in response to the model selection.

5. The method according to claim 1, further comprising:
receiving, from the personal computing device at the server computer, information about the user; and
merging the information about the user with the real property structure in the server computer.

6. The method according to claim 1, further comprising:
receiving a request for a plurality of configurations from the personal computing device at the server computer; and
transmitting from the server computer to the personal computing device a display of the plurality of configurations.

7. The method according to claim 6, further comprising:
receiving one or more requested selections among the plurality of configurations from the personal computing device at the server computer; and
merging the requested selections of the plurality of configurations with the respective graphical images of the real property structure in the server computer.

8. The method according to claim 1, wherein the personal computing device is one of a cellular telephone, a personal desktop computer, a personal notebook computer, a hand-held computing device, or a personal digital assistant.

9. The method according to claim 1, wherein the user-selectable categories includes a siding category, a shingles category, a windows category, a porch post category, a doors category, a shutters category, an exterior trim category, a garage door category, sheathing category, a stone category, a brick category, a decking category, an exterior door hardware category, an exterior lighting category, an exterior paint category, an interior doors and trim category, a rail and spindle category, an interior door hardware category, a fireplaces category, a cabinets category, a countertops category, a tile backsplash category, a sinks category, a tub and showers category, a water closets category, a faucets category, a flooring category and an interior paint category.

10. The method according to claim 1, wherein the personal computing device is remotely located from the server computer.

11. A distributed computing system for managing options and selections for development of a real property structure, the distributed computing system comprising:
a personal computing device of a user configured to communicate over a distributed computing network; and
a server computer with a memory device, a communication device configured to communicate over the distributed computing network, and a processor communicatively connected to the personal computing device via the communications device, the processor being programmed to:
transmit, to the personal computing device of the user, a plurality of user-selectable categories, each of the user-selectable categories including multiple user-selectable options for modifying the real property structure each with a respective descriptor and a respective graphical image;
receive, from the personal computing device of the user, selections of multiple ones of the user-selectable options;
store, in the memory device, a user-modifiable list of the selected ones of the user-selectable options;
generate a graphical representation of the selected options applied to the real property structure; and
display, to the user via an electronic display of the personal computing device, the graphical representation of the selected options applied to the real property structure.

12. The distributed computing system according to claim 11, further comprising a camera configured to transmit to the personal computing device the respective graphical images, wherein the personal computing device is further configured to transmit the respective graphical images to the server computer.

13. The distributed computing system according to claim 11, wherein the server computer is further configured to embed the graphic representation of the selected options applied to the respective graphical images in a web page; and transmit the web page to a web browser of the personal computing device.

14. The distributed computing system according to claim 11, wherein the server computer is further configured to receive from the personal computing device a model selection from a plurality of available real property structures; and assign a copy of a selected one of the plurality of available real property structures to the user as the real property structure within the server computer in response to the model selection.

15. The distributed computing system according to claim 11, wherein the server computer is further configured to receive from the personal computing device information about the user; and merge the information about the user with the real property structure in the server computer.

16. The distributed computing system according to claim 11, wherein the server computer is further configured to receive a request for a plurality of configurations from the personal computing device; and transmit to the personal computing device a display of the plurality of configurations.

17. The distributed computing system according to claim 16, wherein the server computer is further configured to receive one or more requested selections among the plurality of configurations from the personal computing device at the server computer; and merge the requested selections of the plurality of configurations with the respective graphical images of the real property structure.

18. The distributed computing system according to claim 11, wherein the personal computing device is one of a cellular telephone, a personal desktop computer, a personal notebook computer, a hand-held computing device, or a personal digital assistant.

19. The distributed computing system according to claim 11, wherein the user-selectable categories includes a siding category, a shingles category, a windows category, a porch post category, a doors category, a shutters category, an exterior trim category, a garage door category, sheathing category, a stone category, a brick category, a decking category, an exterior door hardware category, an exterior lighting category, an exterior paint category, an interior doors and trim category, a rail and spindle category, an interior door hardware category, a fireplaces category, a cabinets category, a countertops category, a tile backsplash category, a sinks category, a tub and showers category, a water closets category, a faucets category, a flooring category and an interior paint category.

20. The distributed computing system according to claim 11, wherein the personal computing device is remotely located from the server computer.
